(19) United States
(12) Patent Application Publication
(10) Pub. No.: US 2015/0204757 A1
(43) Pub. Date: Jul. 23, 2015

(54) Method for Implementing Rolling Element Bearing Damage Diagnosis

(71) Applicant: Jason Hines, Lexington Park, MD (US)

(72) Inventor: Jason Hines, Lexington Park, MD (US)

(73) Assignee: United States of America as represented by the Secretary of the Navy, Patuxent River, MD (US)

(21) Appl. No.: 14/157,820

(22) Filed: Jan. 17, 2014

(51) Int. Cl. G01M 13/04

(52) U.S. Cl. CPC G01M 13/045

(57) ABSTRACT

A method is provided for implementing fault diagnostics of rolling element bearings in a fleet of rotorcraft. Magnitudes of the bearing defect frequencies derived from vibro-acoustic transducer measurements are used to perform fault detection. Consistent damage detection performance is accomplished using a single measure of bearing component health, which can be used to trigger corrective or risk mitigative actions.

### STATEMENT OF GOVERNMENT INTEREST

The invention described herein may be manufactured and used by or for the Government of the United States of America for governmental purposes without payment of any royalties thereon or therefor.

### BACKGROUND

Bearings are critical components in many mechanical systems, and are especially important in helicopter transmissions, where they support the drive shaft and maintain proper alignment of drive train components. Bearing faults that go undetected can result in costly collateral damage, negatively impact flight safety, and require extended downtime for repairs. Prompt detection of bearing damage can result in significant risk mitigation, operational advantages, and cost savings.

Localized damage on the loaded working surface of a bearing produces very short duration vibration impulses that will excite the structural resonances of the bearing and transmission housing. Successive impulses occur as the defect is repetitively contacted during each rotation of the driveshaft, which modulates the resonant frequencies. This modulation occurs at frequencies that are dependent on the specific geometry of the damaged bearing. The appearance of these signal components in the measured vibration spectrum is a clear indication that a defect is present, and is accompanied by some increase in the narrowband energy due to the excitation of the resonance. These effects can be sensed with vibro-acoustic transducers, such as piezo-electric accelerometers.

The primary bearing defect frequencies are associated with the relative motion of the inner and outer raceways, rolling elements (balls), and the cage. These frequencies are geometry dependent, and thus unique to each bearing design. They can be computed as shown in Equations 1-4 listed below.

$$\begin{matrix}\text{?} = \frac{\text{?}}{2} ( 1 - \frac{α}{\text{?}} cos \text{?} ) \\ ( cage defect frequency ) & Equation 1 \\ \text{?} = \frac{D \text{?}}{2 d} ( 1 - \frac{\text{?}}{\text{?}} \text{?} α ) & Equation 2 \\ \text{?} = N ( \text{?} - \text{?} ) = \frac{N \text{?}}{2} ( 1 + \frac{d}{D} cos α ) \\ ( inner race defect frequency ) & Equation 3 \\ \text{?} = N \text{?} = \frac{N \text{?}}{2} ( 1 - \frac{d}{D} cos α ) \\ ( outer race defect frequency ) , \\ \text{?} \text{indicates text missing or illegible when filed} & Equation 4\end{matrix}$$

Where w_{shaft} is the shaft rotational frequency in radians per second, d is the diameter of the rolling element, D is the pitch diameter, N is the number of rolling elements, and α the contact angle in radians.

A variety of digital signal processing algorithms and filters can be applied to the sensor signal to enhance the visibility of the bearing defect frequencies. This typically involves the removal of dominant frequency components that are normally present (such as gear mesh vibration frequencies). The most prevalent means of detecting bearing defect frequencies involves enveloping a high-frequency band to extract the modulating signal content. This process is also known as the High Frequency Resonance (HFR) method. The presence of bearing defect frequencies in the envelope power spectrum, including their harmonics and sidebands, is interpreted as an indication of a localized bearing defect. In automated implementations, the magnitudes of the bearing defect frequencies are recorded at each time instant for monitoring purposes, and the remainder of the envelope power spectrum is discarded. Large magnitudes of the bearing defect frequencies are assumed to result from damage, and are detected by means of a threshold. A considerable limitation of this approach is that the envelope signal is also unfortunately influenced by numerous benign factors, primarily involving seemingly innocuous differences between like aircraft. The low-noise characteristics of the envelope signal that make it ideal for identifying the effects of low-amplitude modulation, also produce hyper-sensitivity to changes in the random vibration energy. Differences between like aircraft can impact the vibratory transfer function (including the sensor orientation, calibration, and bolt-down torque, and variations in system build-up and assembly), as well as the source vibration itself (lubrication level, shaft misalignment and imbalance, gear backlash, etc.). This causes the baseline magnitudes of the bearing defect frequencies (for healthy unfaulted bearings) to differ significantly from aircraft to aircraft, with effects characterized by correlated, but non-uniform changes across the envelope spectrum. Consequently, even when faults are not present, some aircraft consistently exhibit abnormally low envelope power spectrum magnitudes, while others consistently exhibit abnormally high envelope power spectrum magnitudes, as shown in FIG. 2a. When a bearing fault occurs and a bearing defect frequency is present in the envelop spectrum, its magnitude might be significant relative to adjacent frequencies, but may remain within the normal range of values obtained from other aircraft, as shown in FIG. 2b. This results in a missed detection or extremely late detection. The subsequent application of the same fault detection threshold to every aircraft results in inconsistent sensitivity to faults with higher than desirable rates of false alarms and premature fault detection for aircraft that have normally high values, and late or missed detections in aircraft that have normally low values. An exceedance of the established fleet threshold may be associated with a wide range of damage severity, which is particularly problematic for ensuing interpretation and decision-making Each bearing defect frequency can also exhibit slightly different sensitivity to these effects, due to the frequency response of the bearing, structure, and the sensor internals, as well as the digital signal processing (digital filter roll-off, scalloping losses from the Fast Fourier Transform, etc.).

The inability to consistently infer damage severity is a considerable limitation of currently used technology, which severely hinders the usefulness of automated implementations of this technology. In order to be effective, the detection algorithms must generate actionable fault messages that are directly linked to remediating or damage mitigating steps that the operator can initiate. Ambiguous diagnostic information that requires subjective interpretation must be relegated to off-line analysis. Off-line analysis poses several significant difficulties, in that the collection and analysis of the data becomes very time and resource consuming, interpretation by subject matter experts can be inconsistent, and the latency between data collection and analysis permits rapidly developing faults to go temporarily unchecked, potentially compromising safety of flight.

### SUMMARY

The present invention is directed to a method for implementing rolling element bearing damage diagnosis the needs enumerated above and below.

The present invention is directed to a method for implementing rolling element bearing damage diagnosis using a bearing envelope power spectrum comprising the steps of compiling an input data array using individual parameters derived from the bearing envelope power spectrum and historical fleet data, linearizing and centering the input data array, the input data array having N principal components, where N denotes how many components are in the input data array, the input data array having a first principal component, creating a first transformation matrix from the linearized and centered input data array by removing the first principal component from the linearized and centered input data array while preserving original intuitive meaning of the individual parameters in the input data array, eliminating one term from the first transformation matrix thereby creating a second transformation matrix, the one term serving as a sacrificial variable, computing a first scaled distance metric from the second transformation matrix, computing a second scaled distance metric from the one term eliminated from the first transformation matrix, combining the first scaled distance metric and the second scaled distance metric into a simple equation that produces a single measure of bearing condition, and storing the simple equation for application to future data in order to assess bearing damage.

It is a feature of the invention to provide a method for bearing damage diagnosis that can be used on a fleet of helicopters, or a similar fleet of systems with mechanical power transmissions that utilize rolling element bearings.

It is a feature of the invention to provide a method for bearing damage diagnosis that can monitor the condition of the same bearings on like aircraft, using identically configured monitoring instrumentation and processing.

It is a feature of the present invention to provide a method for bearing damage diagnosis to automatically detect bearing damage at a consistent damage state for all aircraft.

It is a feature of the present invention to provide a method of transforming the magnitudes of the bearing defect frequencies to remove correlated effects in the measured vibration that are contributed by slight differences between individual aircraft.

### DRAWINGS

These and other features, aspects and advantages of the present invention will become better understood with reference to the following description and appended claims, and accompanying drawings wherein

FIG. 1 is a flow chart showing the fault detection process;

FIGS. 2a,b are representative envelope power spectrums depicting the variability that occurs between like aircraft, and the effect when a bearing defect frequency is present; and

FIG. 3 is an Iso-map of the health indicator response as a function of the two scaled distance metrics.

### DESCRIPTION

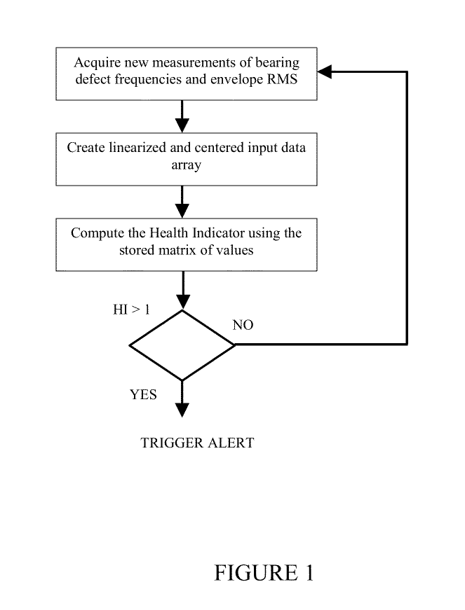

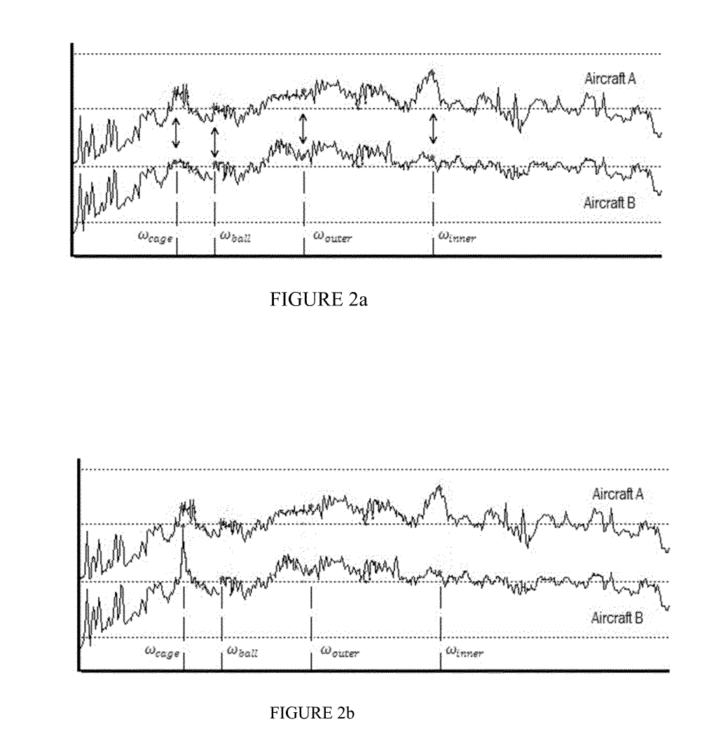

The preferred embodiments of the present invention are illustrated by way of example below and in FIGS. 1-3. As shown in FIG. 1, the method for implementing rolling element bearing damage diagnosis using a bearing envelope power spectrum comprises the steps of compiling an input data array using individual parameters derived from the bearing envelope power spectrum and historical fleet data, linearizing and centering the input data array, the input data array having N principal components, where N denotes how many components are in the input data array, the input data array having a first principal component, creating a first transformation matrix from the linearized and centered input data array by removing the first principal component from the linearized and centered input data array while preserving original intuitive meaning of the individual parameters in the input data array, eliminating one term from the first transformation matrix thereby creating a second transformation matrix, the one term serving as a sacrificial variable, computing a first scaled distance metric from the second transformation matrix, computing a second scaled distance metric from the one term eliminated from the first transformation matrix, combining the first scaled distance metric and the second scaled distance metric into a simple equation that produces a single measure of bearing condition, and storing the simple equation for application to future data in order to assess bearing damage.

In the description of the present invention, the invention will be discussed in a military aircraft environment; however, this invention can be utilized for any type of application that requires bearing damage diagnosis.

Correlated changes in the magnitudes of the bearing defect frequencies caused by benign factors can be isolated from the effects of damage by only considering data obtained from healthy unfaulted components. Such a dataset can be obtained from historical fleet data, preferably using data from numerous individual aircraft, and used to characterize the normal relationships between the magnitudes of the multiple bearing defect frequencies. The variability in the magnitudes of the bearing defect frequencies that is unrelated to damage can be modeled and removed, such that any significant variability can be assumed to be solely related to damage.

In one embodiment of the invention, data vectors are formed at each time instance, for each bearing-sensor pair, using parameters from the envelope power spectrum. The constitutive elements of the data vectors are described in Equation 5.

$$\text{?} ( \text{?} ) = [ \begin{matrix}\text{?} ( \text{?} ) & \text{?} ( \text{?} ) & \text{?} ( \text{?} ) & \text{?} ( \text{?} )\end{matrix} ] \\ \text{?} \text{indicates text missing or illegible when filed} \qquad Equation 5$$

Where:

x₁: Squared Envelope RMS

x₂: Envelope Power Spectrum Magnitude at Ball Defect Frequency

x₃: Envelope Power Spectrum Magnitude at Cage Defect Frequency

x₄: Envelope Power Spectrum Magnitude at Inner Race Defect Frequency

x₅: Envelope Power Spectrum Magnitude at Outer Race Defect Frequency

In the data vector of Equation 5, the first term, x₁, represents the average magnitude of the envelope power spectrum, which reflects changes in signal power. The power spectrum magnitudes of the primary bearing defect frequencies, denoted as elements 2-5, can be optionally excluded from the computation of the squared envelope RMS to improve the orthogonality between x₁ and the remaining terms. The data vector can also be extended to include additional bearing defect frequencies, including harmonics and sidebands of the primary bearing defect frequencies.

The data vector is linearized by computing the logarithm of each element, and then centered by subtracting the fleet mean. The elements of the data vector are squared magnitudes from the power spectrum, which become linearly related after application of the log-transformation due to the following property of logarithms:

$$\text{?} ( \text{?} ) = \text{?} \text{?} ( \text{?} ) \\ \text{?} \text{indicates text missing or illegible when filed} \qquad Equation 6$$

The log-transformation of the data vector is significant because it permits subsequent application of linear transformations. The log-base-10 is preferred, since changes in the power spectrum are more often interpreted in decades. The mean is computed from fleet historical data (excluding data from faulted bearings). These manipulations produce a linearized and centered data vector, as shown in Equation 7.

$$\text{?} ( t ) = \text{?} ( x ( t ) ) - \text{?} \\ \text{?} \text{indicates text missing or illegible when filed} \qquad Equation 7$$

An input data array can be formed by combining the linearized and centered data vectors from the historical fleet data, from each aircraft, α, and each respective time instance, τ. Data from faulted bearings are excluded so that the input data array can be used to characterize the normally occurring relationships between the constitutive parameters of the data vector. This compilation of data vectors is shown in Equation 8.

$$\begin{matrix}\text{?} = [ \begin{matrix}\text{?} \\ \text{?} \\ ⋮ \\ \text{?} \\ \text{?} \\ \text{?} \\ ⋮ \\ \text{?} \\ ⋮\end{matrix} ] & Equation 8 \\ \text{?} \text{indicates text missing or illegible when filed} & \end{matrix}$$

The input data array can be decomposed into N principal components, where N denotes the number of elements (or columns) in the data vector and input data array. The principal components form an orthogonal set of basis vectors that are ranked according to their corresponding variances, with the first principal component having the largest corresponding variance by convention.

A first transformation matrix can be computed from the input data array by removing the first principal component, which corresponds to variability in the magnitudes of the bearing defect frequencies that occur normally. This first transformation matrix can be defined such that the first principal component is removed (by scaling it by zero), while the original intuitive meanings of the bearing defect frequencies are preserved. This first transformation matrix, V, is defined in equations 9 and 10.

$$\begin{matrix}V = {RR}^{T} & Equation 9 \\ B = [ \begin{matrix}\text{?} & \text{?} & \text{?} & \text{?} & 0\end{matrix} ] \\ \text{?} \text{indicates text missing or illegible when filed} & Equation 10\end{matrix}$$

where ξ represents the principal components, which are the eigenvectors of the covariance matrix computed from the input data array.

Thereafter, any newly recorded data vector from the same bearing-sensor pair can be filtered at each time instance to remove the first principal component by multiplication with this first transformation matrix. The multiplication of a data vector by this first transformation matrix is shown in Equation 11.

$$\text{?} \text{?} = [ \begin{matrix}\text{?} & \text{?} & \text{?} & \text{?} & \text{?}\end{matrix} ] [ \begin{matrix}\text{?} & \text{?} & \text{?} & \text{?} & \text{?} \\ \text{?} & \text{?} & \text{?} & \text{?} & \text{?} \\ \text{?} & \text{?} & \text{?} & \text{?} & \text{?} \\ \text{?} & \text{?} & \text{?} & \text{?} & \text{?} \\ \text{?} & \text{?} & \text{?} & \text{?} & \text{?}\end{matrix} ] \\ \text{?} \text{indicates text missing or illegible when filed} \qquad Equation 11$$

The inclusion of the squared envelope RMS term in the data vector, in addition to increasing accuracy, is to serve as a sacrificial term that allows the remaining (N−1) terms to retain a rank of (N−1) after the removal of the dimension corresponding to the first principal component. The unnecessary transformation of the envelope RMS term can be omitted by modifying the first transformation matrix, V, which results in a second transformation matrix, V_{transformation}. This second transformation matrix, as shown in Equation 12, is obtained by removing the column of the first transformation matrix associated with the squared envelope RMS term (in this case, the first column, from left).

$$\text{?} [ \begin{matrix}\text{?} & \text{?} & \text{?} & \text{?} \\ \text{?} & \text{?} & \text{?} & \text{?} \\ \text{?} & \text{?} & \text{?} & \text{?} \\ \text{?} & \text{?} & \text{?} & \text{?} \\ \text{?} & \text{?} & \text{?} & \text{?}\end{matrix} ] \\ \text{?} \text{indicates text missing or illegible when filed} \qquad Equation 12$$

The multiplication of a data vector with this second transformation matrix produces a transformed data vector, x_{transformed}, with (N−1) elements that correspond to the transformed magnitudes of the bearing defect frequencies, as shown in Equation 13.

$$- - [ \begin{matrix}\text{?} & \text{?} & \text{?} & \text{?} & \text{?}\end{matrix} ] [ \begin{matrix}\text{?} & \text{?} & \text{?} & \text{?} \\ \text{?} & \text{?} & \text{?} & \text{?} \\ \text{?} & \text{?} & \text{?} & \text{?} \\ \text{?} & \text{?} & \text{?} & \text{?} \\ \text{?} & \text{?} & \text{?} & \text{?}\end{matrix} ] \\ \text{?} \text{indicates text missing or illegible when filed} \qquad Equation 13$$

Unique transformation matrices can be developed for each relevant bearing-sensor pairing on the aircraft, stored in the on-board software, and applied to each newly recorded data vector in order to remove the sensitivity to benign factors.

At each time instance, a single measure of bearing health can be computed by taking the product of two scaled distance metrics. The L₂-norm of the transformed data vector is scaled by a threshold value (C_{BearingThreshold}) to produce the first scaled distance metric, which nominally has a 0-1 value (the L₂-norm is defined as the square-root of the inner product, or the summation over the squared terms). The resultant equation is shown in Equation 14.

$$\text{?} = \sqrt{\text{?} ( \frac{\text{?} \text{?}}{\text{?}} ) \text{?}} \\ \text{?} \text{indicates text missing or illegible when filed} \qquad Equation 14$$

A second scaled distance metric, D_{RMS}, can be defined using the squared envelope RMS term omitted from the computation of the first scaled distance metric, which reflects the resonance response of the bearing/structure.

$$\text{?} = \frac{\sqrt{\text{?}}}{\text{?}} \\ \text{?} \text{indicates text missing or illegible when filed} \qquad Equation 15$$

These scaled distance metrics provide two approximately independent indicators of bearing damage. Simultaneous responses of both scaled distance metrics are particularly indicative of bearing damage, and as shown in Equation 16, can be used jointly to provide a Health Indicator (HI), which serves as a single measure of bearing condition:

$$HI = \text{?} \text{?} \\ \text{?} \text{indicates text missing or illegible when filed} \qquad Equation 16$$

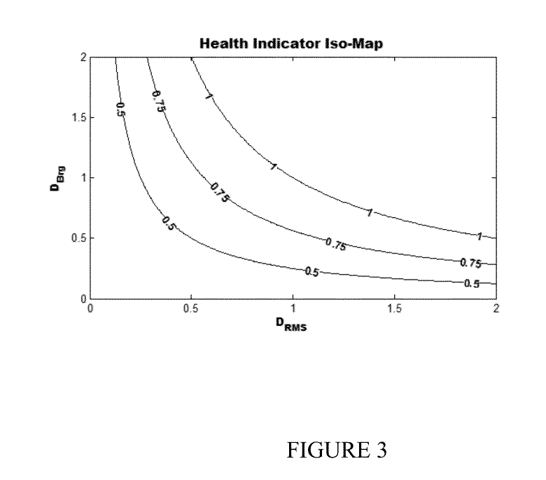

Both distance measures are scaled such that their output is evaluated on a 0-1 scale. This produces similarly scaled HI values, but de-emphasizes increases of an individual scaled distance metric that are much less likely to be related to a bearing fault, as shown in FIG. 3. The HI can be re-expressed such that only a small matrix, V_{HI}, must be stored in memory for every bearing-sensor pairing, along with the fleet means. This matrix is defined in equations 17 and 18.

$$\begin{matrix}HI = \sqrt{\text{?}} \cdot \sqrt{\text{?} \text{?} \text{?}} & Equation 17 \\ \text{?} \text{?} ( \frac{\text{?} \text{?}}{\text{?} \text{?}} ) \\ \text{?} \text{indicates text missing or illegible when filed} & Equation 18\end{matrix}$$

In an alternative embodiment of the invention, an additional normalization can be incorporated into the transformation matrix to uniformly scale the magnitudes of the bearing defect frequencies by their standard deviation. The standard deviation along each principal component is equal to the square-root of the eigenvalues, λ(corresponding to the previously computed eigenvectors). This results in a modified first transformation matrix, as shown in Equation 19, that can be subsequently converted into the second transformation matrix as previously described.

$$\text{?} = \text{?} \text{?} \text{?} \\ \text{?} \text{indicates text missing or illegible when filed} \qquad Equation 19$$

As shown in Equation 20, Σ [symbol] is a diagonal 5×5 matrix that assumes a reverse-ordering of the principal components:

$$\text{?} = [ \begin{matrix}\frac{1}{\sqrt{\text{?}}} & … & 0 \\ ⋮ & ⋱ & ⋮ \\ 0 & … & \frac{1}{\sqrt{\text{?}}}\end{matrix} ] \\ \text{?} \text{indicates text missing or illegible when filed} \qquad Equation 20$$

In another embodiment of the invention, the envelope RMS term can be excluded from the input data vector, and the first transformation matrix used in place of the second transformation matrix for computation of the HI. In this implementation, the N magnitudes of the bearing defect frequencies are projected into an N-1 subspace that does not preserve the intuitive meaning of the bearing defect frequencies as distinct failure modes. For that reason, the inclusion of the envelope RMS term is preferred.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A method for implementing rolling element bearing damage diagnosis using a bearing envelope power spectrum, the method comprising the steps of:
compiling an input data array using individual parameters derived from the bearing envelope power spectrum and historical fleet data;
linearizing and centering the input data array, the input data array having N principal components, where N denotes how many components are in the input data array, the input data array having a first principal component;
creating a first transformation matrix from the linearized and centered input data array by removing the first principal component from the linearized and centered input data array while preserving original intuitive meaning of the individual parameters in the input data array;
eliminating one term from the first transformation matrix thereby creating a second transformation matrix, the one term serving as a sacrificial variable;
computing a first scaled distance metric from the second transformation matrix;
computing a second scaled distance metric from the one term eliminated from the first transformation matrix;
combining the first scaled distance metric and the second scaled distance metric into a simple equation that produces a single measure of bearing condition; and
storing the simple equation for application to future data in order to assess bearing damage.
